(19) United States
(12) Patent Application Publication
(10) Pub. No.: US 2012/0268650 A1
(43) Pub. Date: Oct. 25, 2012

(54) SYSTEM AND METHOD FOR A THIN-CLIENT TERMINAL SYSTEM USING A SERIAL BUS

(75) Inventors: Young Gil Song, Palo ALto, CA (US); Stephen Dukker, San Francisco, CA (US)

(73) Assignee: NCOMPUTING INC., REDWOOD CITY, CA (US)

(21) Appl. No.: 13/499,537

(22) PCT Filed: Oct. 1, 2010
(86) PCT No.: PCT/US10/51207

§ 371 Date: Jul. 11, 2012

Related U.S. Application Data
(60) Provisional application No. 61/248,307, filed on Oct. 2, 2009.

(51) Int. Cl. H04N 7/01; G06F 21/20; G06F 15/16

(52) U.S. Cl. 348/441; 709/253; 726/3; 348/E07.003

(57) ABSTRACT

Thin-client terminal systems allow computer systems to be shared by multiple computer users. With modern technology, the cost of implementing a thin-client terminal system can be very low. To expand the market for thin-client terminal systems, a serial bus interface is used to couple a thin-client terminal system to a computer system.

### CROSS-REFERENCE TO RELATED APPLICATIONS

This application claims the benefit of U.S. Provisional Patent Application Ser. No. 61/248,307, filed Oct. 2, 2009 (“SYSTEM AND METHOD FOR A THIN-CLIENT TERMINAL SYSTEM USING A SERIAL BUS”), which is incorporated herein in its entirety by this reference.

### TECHNICAL FIELD

The present invention relates to the fields of terminal systems. In particular, but not by way of limitation, the present invention discloses techniques for implementing a thin-client graphics terminal system.

### BACKGROUND OF THE INVENTION

Centralized computer systems with multiple independent terminal systems for accessing the centralized computer systems were once the dominant computer system architecture. These centralized computer systems were initially very expensive mainframe or mini-computer systems that were shared by multiple computer users. Each of the computer system users accessed the centralized computer systems using a computer terminal system coupled to the centralized computer systems.

In the late 1970s and early 1980s, semiconductor microprocessors and memory devices allowed for the creation of inexpensive personal computer systems. Personal computer systems revolutionized the computing industry by allowing each individual computer user to have access to a full computer system without having to share the computer system with any other computer user. Each personal computer user could execute their own software applications and any problems with the computer system would only affect that single personal computer system user.

Although personal computer systems have become the dominant form of computing in the modern world, there has been a resurgence of the centralized computer system model wherein multiple computer users access a single server system using modern terminal systems that include high-resolution graphics. Computer terminal systems can significantly reduced computer system maintenance costs since computer terminal users cannot easily introduce computer viruses into the main computer system or load other unauthorized computer programs. Terminal based computing also allows multiple users to easily share the same set of software applications.

Modern personal computer systems have become increasingly powerful in the decades since the late 1970's personal computer revolution. Modern personal computer systems are now more powerful than the shared mainframe and mini-computer systems of the 1970's. In fact, modern personal computer systems are so powerful that the vast majority of the computing resources in modern personal computer systems generally sit idle when a typical computer user uses a modern personal computer system. Thus, personal computer systems can now easily serve multiple computer users.

### BRIEF DESCRIPTION OF THE DRAWINGS

In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

FIG. 1 illustrates a diagrammatic representation of machine in the example form of a computer system within which a set of instructions, for causing the machine to perform any one or more of the methodologies discussed herein, may be executed.

FIG. 2A illustrates a block diagram of a first example embodiment of a thin-client terminal system coupled to a thin-client server computer system.

FIG. 2B illustrates a high-level block diagram of the example single thin-client server computer system of FIG. 2A supporting multiple individual thin-client terminal systems using multi-conductor wire that includes analog signals and electrical power.

FIG. 3 illustrates a block diagram of a first example embodiment of a thin-client terminal system implemented using a serial bus as a data communication link to a server.

FIG. 4 illustrates a block diagram of a example second embodiment of a thin-client terminal system implemented using a serial bus as a data communication link to a server.

FIG. 5 illustrates a block diagram of a example thin-client environment wherein connections between thin-client terminal systems and a thin-client server system are implemented using a serial bus as a data communication link.

FIG. 6 illustrates a flowchart of an example embodiment of a method of providing a thin-client terminal system.

### DETAILED DESCRIPTION

The following detailed description includes references to the accompanying drawings, which form a part of the detailed description. The drawings show illustrations in accordance with example embodiments. These embodiments, which are also referred to herein as “examples,” are described in enough detail to enable those skilled in the art to practice the invention. It will be apparent to one skilled in the art that specific details in the example embodiments are not required in order to practice the present invention. For example, although the example embodiments are mainly disclosed with reference to a thin-client system, the teachings can be used in other environments. The example embodiments may be combined, other embodiments may be utilized, or structural, logical and electrical changes may be made without departing from the scope what is claimed. The following detailed description is, therefore, not to be taken in a limiting sense, and the scope is defined by the appended claims and their equivalents.

In this document, the terms “a” or “an” are used, as is common in patent documents, to include one or more than one. In this document, the term “or” is used to refer to a non-exclusive or, such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

Computer Systems

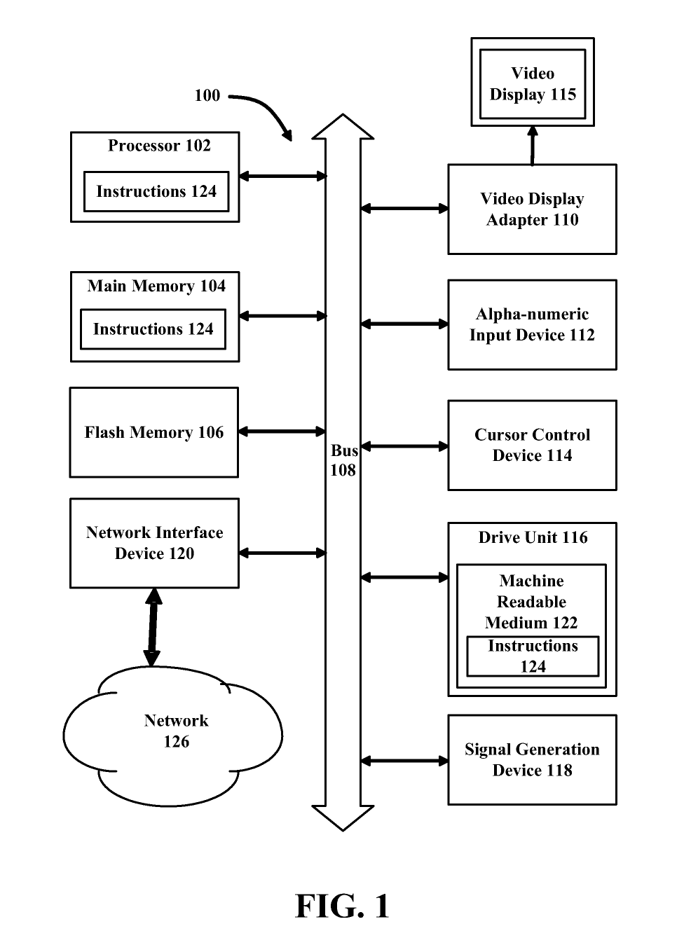

The present disclosure concerns digital computer systems. FIG. 1 illustrates a diagrammatic representation of machine in the example form of a computer system 100 that may be used to implement portions of the present disclosure. Within computer system 100 there are a set of instructions 124 that may be executed for causing the machine to perform any one or more of the methodologies discussed herein. In a networked deployment, the machine may operate in the capacity of a server machine or a client machine in client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of computer instructions (sequential or otherwise) that specify actions to be taken by that machine. Furthermore, while only a single machine is illustrated, the term “machine” shall also be taken to include any collection of machines that individually or jointly execute a set (or multiple sets) of instructions to perform any one or more of the methodologies discussed herein.

The example computer system 100 includes a processor 102 (e.g., a central processing unit (CPU), a graphics processing unit (GPU) or both), a main memory 104 and a flash memory 106, which communicate with each other via a bus 108. The computer system 100 may further include a video display adapter 110 that drives a video display system 115 such as a Liquid Crystal Display (LCD) or a Cathode Ray Tube (CRT). The computer system 100 also includes an alphanumeric input device 112 (e.g., a keyboard), a cursor control device 114 (e.g., a mouse or trackball), a disk drive unit 116, a signal generation device 118 (e.g., a speaker) and a network interface device 120.

The disk drive unit 116 includes a machine-readable medium 122 on which is stored one or more sets of computer instructions and data structures (e.g., instructions 124 also known as ‘software’) embodying or utilized by any one or more of the methodologies or functions described herein. The instructions 124 may also reside, completely or at least partially, within the main memory 104 and/or within the processor 102 during execution thereof by the computer system 100, the main memory 104 and the processor 102 also constituting machine-readable media.

The instructions 124 may further be transmitted or received over a computer network 126 via the network interface device 120. Such transmissions may occur utilizing any one of a number of well-known transfer protocols such as the well known File Transport Protocol (FTP).

While the machine-readable medium 122 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies described herein, or that is capable of storing, encoding or carrying data structures utilized by or associated with such a set of instructions. The term “machine-readable medium” shall accordingly be taken to include, but not be limited to, solid-state memories, optical media, and magnetic media.

For the purposes of this specification, the term “module” includes an identifiable portion of code, computational or executable instructions, data, or computational object to achieve a particular function, operation, processing, or procedure. A module need not be implemented in software; a module may be implemented in software, hardware/circuitry, or a combination of software and hardware.

Personal Computer Revolution

Before the advent of the inexpensive personal computer, the computing industry largely used centralized mainframe or mini-computers that were coupled to a plurality of “dumb” terminal systems. Such terminal systems are referred to as ‘dumb’ terminals since the computing ability resided within the mainframe or mini-computer and the terminal system was merely used to display output information on a video screen and accept alpha-numeric input from a keyboard . . . . No software applications execute locally on the terminal system itself (except dedicated firmware to implement the terminal functionality). Computer operators shared the mainframe computer among multiple individual computer users that each used individual terminal systems coupled to the mainframe computer. These terminal systems generally had very limited graphics capabilities and were mostly displaying only alpha-numeric characters on the display screen of the terminal system.

With the introduction of the modern personal computer system, the use of dumb terminals largely disappeared since personal computer systems were much more cost effective. Individual personal computer users could run useful software applications on their own personal computer system. When the services of a dumb terminal were required to interface with a legacy terminal-based mainframe computer system, a personal computer system could easily execute a terminal emulation program that would emulate the operations of a dumb terminal at a low cost that was generally similar to the cost of a dedicated dumb terminal. Thus, a single system could operate as both a personal computer system for running local applications and a terminal system to access a larger terminal-based computer system.

During the personal computer revolution, personal computers introduced high resolution graphics and cursor control devices (such as the computer mouse) to personal computer users. The combination of high-resolution graphics displays and cursor control devices allowed for much more intuitive computer user interfaces than a primitive text-only display screen. For example, virtually all current personal user interface systems now use multiple windows, icons, and pull-down menus that are implemented with high resolution graphics and navigated with a cursor control device. Furthermore, high-resolution graphics allowed for applications that used photos, videos, and graphical images.

Over the past few decades, personal computer systems have greatly increased in power. Processors run at much higher clock speeds and process larger amounts of data per each clock cycle. Processors now even have multiple internal cores such that personal computer systems are now often multi-processor systems. The main memory systems in personal computer systems have gone from being measured in kilobytes to gigabytes. And hard drives that did not even exist for personal computers when personal computers were first introduced now store terabytes of data. Thus, at this point in history, even average personal computer systems are now much more powerful than the mainframe systems that personal computer systems were displacing. Modern personal computer operating systems now even include features for supporting multiple users simultaneously just like the old centralized mainframe computer systems.

Modern Thin-Client Terminal Systems

In recent years, a new generation of terminal systems that support high-resolution graphics have been introduced into the computer market. These new terminal systems have allowed a new generation of users to rediscover many of the advantages of a terminal-based computing architecture. For example, computer terminals allow for improved computer system security and reduced maintenance costs since users of computer terminal systems cannot easily introduce computer viruses by downloading or installing new software into the computer system from the terminal system. Thus, with a centralized computer system having multiple terminals, only the main centralized computer server system needs to be closely monitored and maintained. The stateless terminal systems require almost no maintenance at all.

One category of these modern terminal systems is called “thin client” systems since the terminal systems are a “client” to main computer system that acts as a server and the terminal systems are designed to be very simple and limited (thus “thin”). The thin-client terminal systems primarily depend on a thin-client server system for all (or nearly all) of their application processing activities. A thin-client terminal system thus mainly focuses only on conveying output from the centralized server system to the user and input from the user to the centralized server system.

The new generation of computer terminal systems provide features that did not exist during the prior era of computer terminal usage. Specifically, modern terminal systems include modern amenities such as high-resolution graphics capabilities, audio output, and cursor control system input (mouse, trackpad, trackball, etc.). Thus, modern terminal systems can provide all the features that users of modern personal computer systems have become accustomed to using.

A First Thin-Client System Example Embodiment

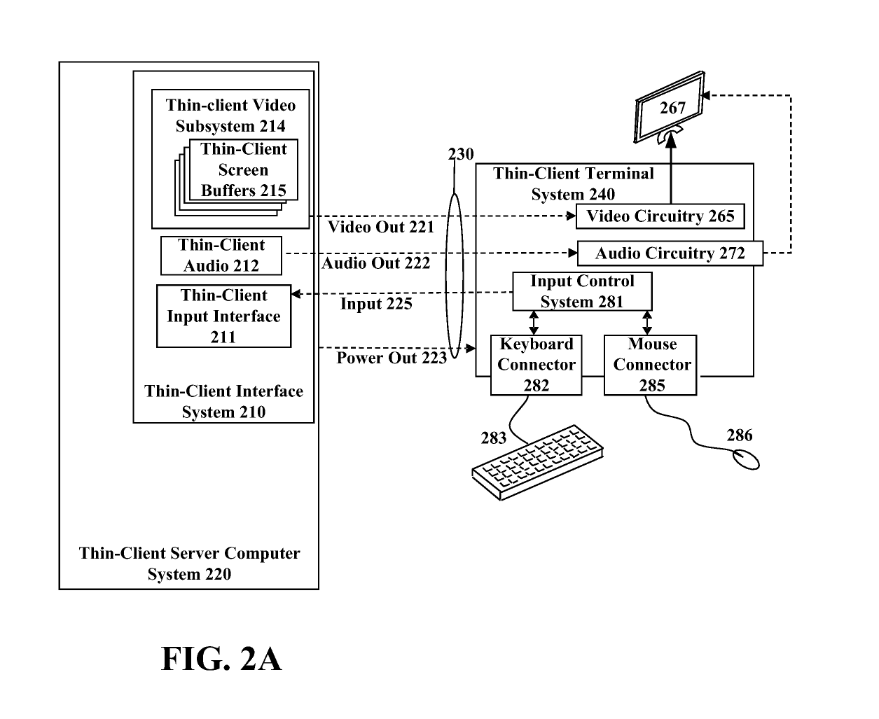

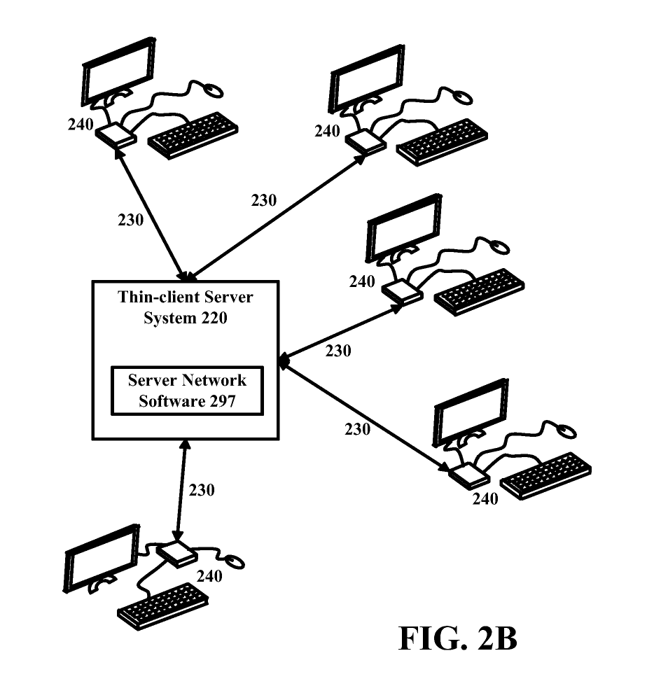

FIG. 2A illustrates a block diagram of a first type of thin-client terminal architecture. In the thin-client architecture of FIG. 2A, a server computer system 220 is illustrated coupled to one (of possibly many) thin-client terminal system 240. The thin-client server computer system 220 and thin-client terminal system 240 are coupled with a multi-conductor cable 230 that carries input from a user of the thin-client terminal system 240 to the thin-client server computer system 220 and output from the thin-client server computer system 220 to the thin-client terminal system 240.

FIG. 2B illustrates a conceptual diagram of the server computer system 220 from FIG. 2A providing computer processing resources to a plurality of individual thin-client terminal systems 240. A single thin-client server computer system 220 is coupled to several individual thin-client terminal systems 240 in a hub-and-spoke arrangement since the embodiment of FIG. 2A requires a direct connection between the thin-client server computer system 220 and each of the thin-client terminal systems 240. The individual thin-client terminal systems 240 are served using thin-client server network software 297 running on thin-client server computer system 220.

Referring back to FIG. 2A, the thin-client terminal system 240 acts largely as a simple pass-through system such that most of the hardware for driving the thin-client terminal system 240 actually resides within the server computer system 220. This type of thin-client system architecture allows the actual thin-client terminal devices 240 in the implementation of FIG. 2A to be very inexpensive. However, to use the simple thin-client terminal system 240 illustrated in FIG. 2A with a personal computer system (such as thin-client server computer system 220), additional add-on hardware and software needs to be added to the personal computer system. In one embodiment, the add-on hardware may be implemented as an add-on PCI card that may be added to the personal computer system. However, other methods of adding the needed hardware may be used such as using an add-on Universal Serial Bus (USB) peripheral device.

In the embodiment of FIG. 2A, a thin-client interface system 210 is responsible for interacting with all of the attached thin-client terminal systems 240. To generate video output for each thin-client terminal system 240, a thin client video subsystem 214 in the server system 220 maintains a screen buffer 215 for each of the each thin-client terminal systems 240. Video display circuitry within the server system 220 reads the screen buffer 215 contents and drives a video output signal 221 for each thin-client terminal system 240. Relatively simple video circuitry 265 in the thin-client terminal system 240 passes the video output signal to a video display monitor 267. Audio may be handled in a similar manner wherein a thin-client audio system 212 generates audio output 222 for each thin-client terminal systems 240. In the embodiment of FIG. 2A, the audio information is also passed from audio circuitry 272 to the audio input of a display monitor 267 that is capable of outputting audio. In one embodiment, the thin-client audio system 212 outputs a digital auto signal to the thin-client terminal system 240 which is then decoded and demodulated by the audio circuitry 272 into an analog audio signal at the thin-client terminal system 240.

Input from the thin-client terminal system 240 is handled using an input control system 281 that receives user input information from a keyboard 283 (coupled to a keyboard connector 282) and a cursor control device 286 (such as a mouse) that is coupled to a cursor control device input connector 285. The input control system 281 encodes the user input information (keystrokes and cursor control device movements) and passes that user input information to a thin-client input interface system 211 in the server system 220. In one particular embodiment, the design of the thin-client terminal systems 240 is so efficient that each thin-client terminal system 240 receives all of its needed electrical power from a power out conductor 223 in the multi-conductor wire 230.

On the server side, the thin-client server computer system 220 is equipped with software for interacting with one or more thin-client terminal systems. As illustrated in FIG. 2A, a thin-client interface system 210 within thin-client server system 220 supports the thin-client terminal system 240 (as well as other thin-client terminal systems depending on the implementation) coupled to thin-client server system 220. Each thin-client terminal system 240 supported by thin-client server system 220 will have its own dedicated screen buffer 215 within the thin-client video subsystem 214 of the thin-client server system 220.

The thin-client terminal system illustrated in FIGS. 2A and 2B is very inexpensive and operates very well. But the thin-client terminal system illustrated in FIGS. 2A and 2B does have some drawbacks. As set forth in FIG. 2B, each thin-client terminal system 240 is coupled to the thin-client server system 220 with its own individual multi-conductor cable 230. Thus, there must be an equal number of interfaces on the thin-client server system 220 to accept the multi-conductor cables 230. An ordinary personal computer lacks such interfaces such that a personal computer system must be modified by opening up the personal computer and adding one more peripheral cards to provide these interfaces. Peripheral Component Interconnect (PCI) cards may be added to a personal computer system provide such interfaces. In one embodiment, each PCI card may add up to five thin-client terminals. However, many personal computer users are uncomfortable with opening up a computer system and adding peripheral cards to the computer system. Thus, such users would never purchase the system disclosed in FIGS. 2A and 2B.

A USB-Based Thin-Client Terminal System Example Embodiment

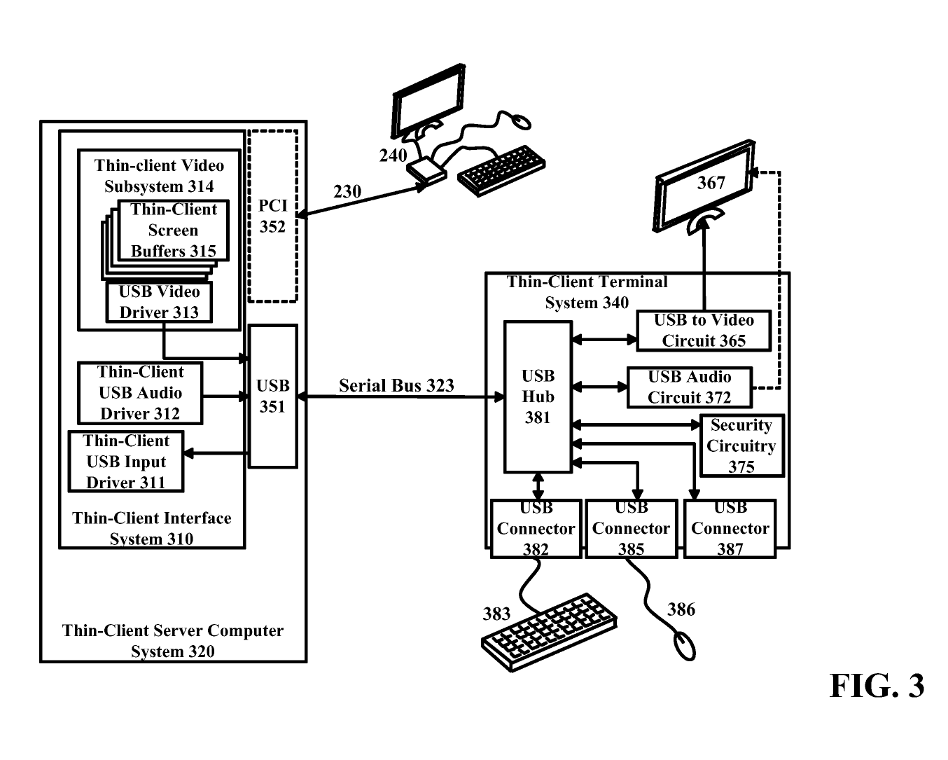

To provide an inexpensive alternative to the thin-client terminal system illustrated in FIGS. 2A and 2B, the present disclosure introduces a serial bus-based thin-client terminal system. Specifically, FIG. 3 illustrates a block diagram of a first embodiment of a thin-client terminal system 340 implemented using a serial bus 323 as a data communication link to a server.

The thin-client terminal system 340 contains a USB hub circuit 381. Although the USB hub circuit 381 is very much like other USB hub circuits and may be implemented with an off-the-shelf USB hub integrated circuit, the USB hub circuit 381 includes an identifier that will identify it as a thin-client terminal system instead of a typical USB hub. In that manner, when the thin-client terminal system 340 is coupled to a USB host controller of the personal computer system, the USB host controller of the personal computer system will activate a USB driver associated with the thin-client terminal system 340 upon receipt of the identifier.

Coupled to the USB hub circuit 381 are USB connectors 382 and 385 for allowing a keyboard 383 and cursor control device 386 to the coupled to the thin-client terminal system 340. In this manner, user input systems are provided to the user of the thin-client terminal system 340.

In addition to the USB connectors 382 and 385 for user input, an additional USB connector 387 may be provided. It is contemplated that more than one additional USB connector may be provided. In this manner, a user of the thin-client terminal system 340 can use supported USB peripherals such as USB memory sticks to store personal data files. Various other USB devices may also be supported. However, the thin-client interface system 310 in the server system 320 may limit the types of USB devices that may be used for security and performance reasons. For example, if a user attempted to use a video capture device, the bandwidth usage of the serial bus 323 and the processing power of the server system 320 may become overtaxed.

To provide audio capabilities, a USB-based audio circuit 372 may be coupled the USB hub circuit 381. Numerous off-the-shelf integrated circuits for receiving digital audio information on a USB connection and outputting audio may be used to implement the USB-based audio circuit 372.

Finally, to provide display capabilities for the thin-client terminal system 340, a USB-to-video circuit 365 is coupled to the USB hub circuit 381. As with the USB-based audio circuit 372, there are off-the-shelf integrated circuits that may be used to implement the USB-based video circuit 365. The USB-to-video circuit 365 receives digital video information on a USB connection and then outputs a video signal to drive a personal computer display. A typical USB-to-video circuit 365 receives a stream of digital display data that is divided into individual scan lines. The USB-to-video circuit 365 then uses this digital video data to render an analogous video signal such as a VGA video signal to drive the local terminal display device 367. Thus, thin-client terminal system 340 retains its characteristic as a pass-through system while also offering a generic and commonly used mechanism (e.g., USB) by which to connect the thin-client terminal system 340 to the thin-client server computer system 320.

To drive the new serial bus-based thin-client terminal system 340, the terminal software on the thin-client server system 320 must be modified. However, no hardware modification of a typical personal computer system is needed to drive the serial bus-based thin-client terminal system 340. To handle the new serial bus-based thin-client terminal system 340, USB drivers are added for the input and output functions of the serial bus-based thin-client terminal system 340.

A USB video driver 313 has been added to the thin-client server system 320 to handle video for the serial bus-based thin-client terminal system 340. The USB video driver 313 operates as a standard video driver in the operating system of the thin-client server system 320. The USB video driver 313 sends video data to the USB host controller 351 of the thin-client server system 320 which is then transmitted to the serial bus-based thin-client terminal system 340. The thin-client USB audio driver 312 operates in a similar manner. All audio requests for thin-client terminal system 340 are directed to the USB audio driver 312 which encodes the audio information and transmits the sound information across series bus 323 using USB host controller 351.

User input information from the thin-client terminal system 340 will be transmitted from USB hub 381 in the thin-client terminal system 340 across serial bus 323 to USB host controller 351. The USB host controller 351 will then provide the user input information to thin-client USB input driver 311. Note that the thin-client interface software 310 will know the input information is specifically from thin-client terminal system 340 since that input information was delivered from USB hub 381 that identified itself as a terminal system.

To prevent unscrupulous entities from creating inferior copies of the thin-client terminal system 340, the thin-client terminal system 340 may include security circuitry 375. The thin-client interface system 310 in the thin-client server system 320 will consult with the security circuitry 375 to determine whether the thin-client terminal system 340 is an approved authentic thin-client terminal system. If a thin-client terminal system 340 fails to properly authenticate itself, then the thin-client terminal system may be deemed an unauthorized device such that the thin-client server system 320 may refuse to provide service to that thin-client terminal system 340. Numerous different security authentication systems may be used to implement the security circuitry 375. Examples of security systems include having the thin-client server system 320 consult a centralized licensing server to determine if a particular encrypted serial number in the security circuitry 375 is authentic and has been activated, allowing a smartcard to be coupled to the security circuitry 375 to activate the thin-client terminal system 340, and receiving a license code that can be entered into a thin-client server system 320 that will allow it to operate with the thin-client terminal system 340 having the security circuitry 375.

The thin-client terminal system 340 can be allowed to operate in parallel with an existing thin-client terminal system, such as thin-client terminal system 240 of FIG. 2. Specifically, the thin-client server system 320 may include a PCI interface card 352 used to implement the system of FIGS. 2A and 2B. In this manner, the thin-client server system 320 can provide terminal services to both the thin-client terminal system 240 implemented with a multi-conductor cable 230 and to the thin-client terminal system 340 implemented with a serial bus 323.

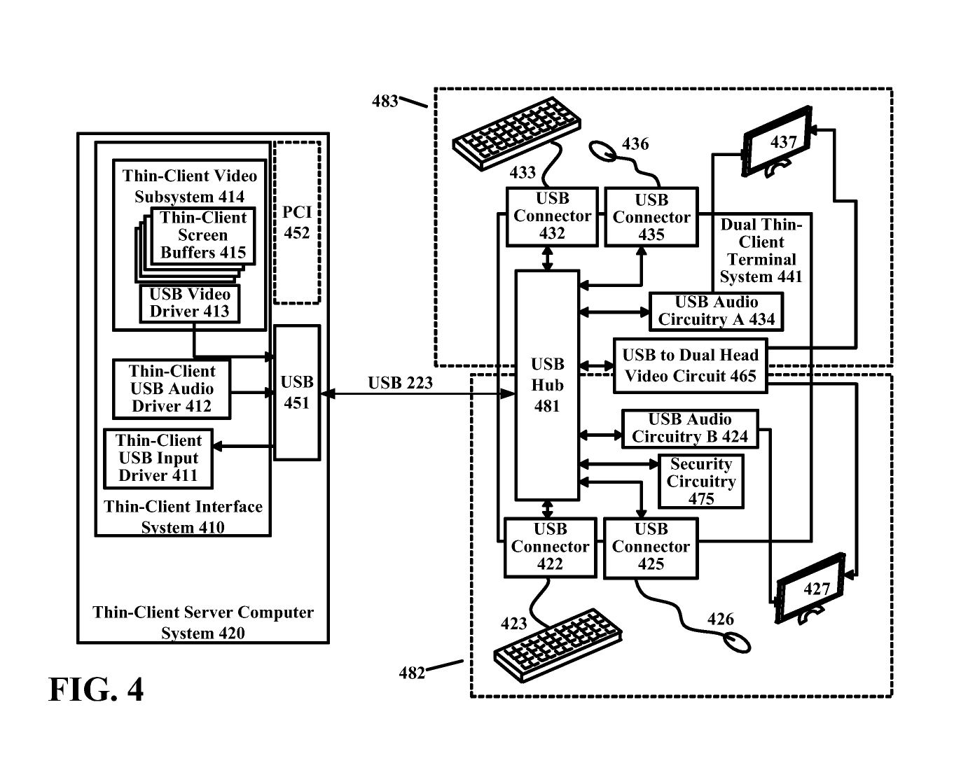

Various different implementations of the serial bus-based thin-client terminal system may be created. FIG. 4 illustrates an alternate implementation wherein two different terminal workstations 482 and 483 are illustrated. The two different workstations are supported with a single USB-to-dual-head video circuit 465. The USB-to-dual-head video circuit may be a graphics circuit that handles video data driven by the thin-client server computer system to the thin-client terminal system. Similar to the USB-to-video circuit 365 of FIG. 3, the USB-to-dual-head video circuit uses the driven video data to render an analog video signal such as a VGA video signal to drive two local terminal display device 437 and 427 for two thin-client terminal systems. In this manner, two terminal workstations 482 and 483 can be supported using a single dual thin-client terminal system 441.

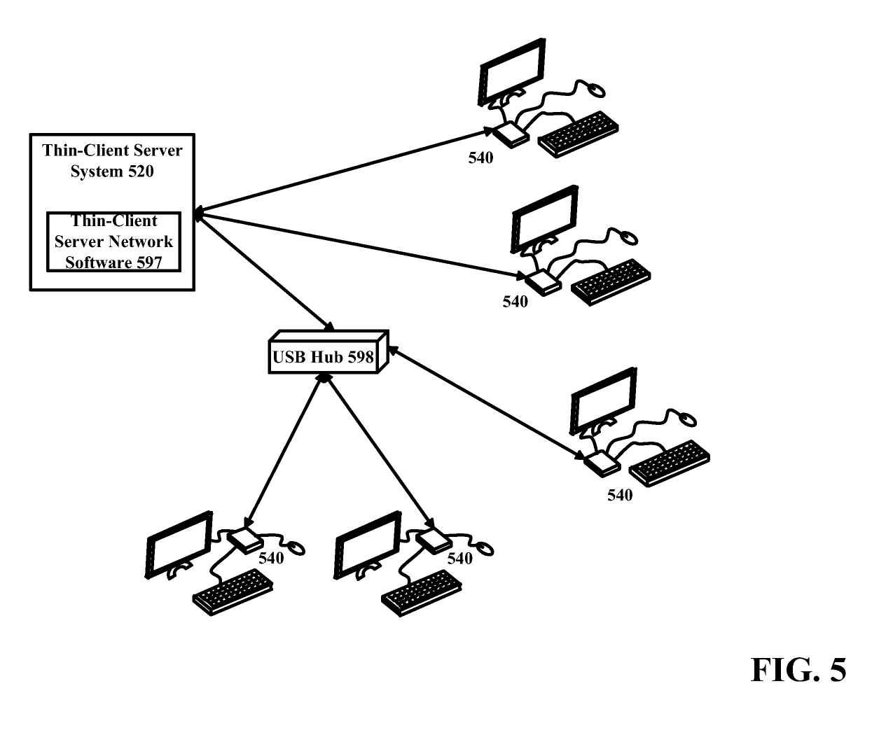

Thus, the system disclosed in FIG. 3 allows users who do not wish to add hardware into a computer system to easily deploy a thin-client terminal system. The user simply adds serial bus based thin-client terminal systems to the externally exposed serial bus of the computer system. FIG. 5 illustrates an example deployment of a thin-client terminal environment that uses serial bus based thin-client terminal systems 540. The thin-client terminal systems 540 may be coupled directly to the thin-client server system 520 or coupled to the thin-client server system 520 through the use of an additional USB hub 598.

An Example Method for Providing a Thin-Client Terminal System

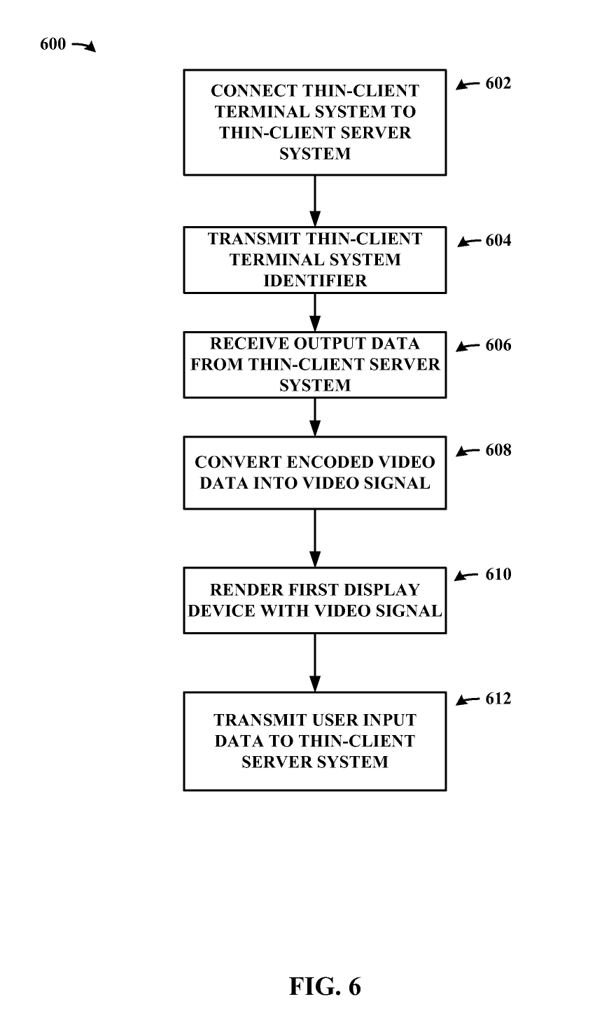

FIG. 6 illustrates an example method 600 of providing a thin-client terminal system. At operation 602, a thin-client terminal system may be connected to a thin-client server system. The connection may be accomplished by connecting a serial bus cable between a serial bus host controller of the thin-client server system and a serial bus hub of the thin-client terminal system. In an example embodiment, the serial bus interface employed may be of the USB format.

At operation 604, the serial bus hub of the thin-client terminal system may transmit an identifier to the thin-client server system that identifies the serial bus hub as being associated with a thin-client terminal system. In response to the identifier, the thin-client server system may activate a serial bus driver associated with the thin-client terminal system. The serial bus driver may support the thin-client terminal system by driving output data to the thin-client terminal system.

At operation 606, the serial bus hub of the thin-client terminal system may receive output data from the thin-client server system. The output data may be encoded according to a serial bus data format. The output data may included encoded video data and audio data.

At operation 608, a serial bus-to-video circuit in the thin-client terminal system may receive the encoded output video data and convert the encoded output video data into an analog video signal. In an example embodiment, the analog video signal may be a VGA signal.

At operation 610, the serial-bus-to-video circuit in the thin-client terminal system may render a first video display device using the analog video signal. In additional example embodiments, the serial-bus-to-video circuit may render a second video display device using the analog video signal.

At operation 612, the thin-client terminal system may transmit user input data to the thin-client server computer system via the serial bus hub. The user input data may be received from one or more serial bus input devices (e.g., keyboard, mouse) connected to serial bus connectors in the thin-client terminal system.

Additional operations of the example method 600 may include authenticating the thin-client terminal system using a security circuit. If a determination is made that the thin-client terminal system is unauthentic, the security circuit may prevent the thin-client terminal system from interfacing with the thin-client server system. Authentication of the thin-client terminal system may comprise consulting a centralized licensing server to determine that an encrypted serial number in the thin-client terminal system is authentic and has been activated. Authentication of the thin-client terminal system may further comprise using a smartcard coupled to the security circuit to activate the thin-client terminal system.

Authentication of the thin-client terminal system also may include receiving a license code enabling the thin-client terminal system to operate.

The preceding technical disclosure is intended to be illustrative, and not restrictive. For example, the above-described embodiments (or one or more aspects thereof) may be used in combination with each other. Other embodiments will be apparent to those of skill in the art upon reviewing the above description. The scope of the claims should, therefore, be determined with reference to the appended claims, along with the full scope of equivalents to which such claims are entitled. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The Abstract is provided to comply with 37 C.F.R. §1.72(b), which requires that it allow the reader to quickly ascertain the nature of the technical disclosure. The abstract is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment.

What is claimed is:

1. A thin-client terminal system, comprising:
a serial bus hub coupled to a server system via a serial bus cable and configured to:
receive serial output data from the server system via the serial bus cable;
transmit input data via the serial bus cable to the server system; and
identify the serial bus hub as associated with the thin-client terminal system;
a first serial bus interface communicatively coupled to the serial bus hub and configured to receive the input data from an input device; and
a serial bus-to-video circuit configured to:
convert received serial output data into a video signal; and
render a first video display device using the video signal, the first video display device connected to the thin-client terminal system.

2. The thin-client terminal system of claim 1, further comprising a second serial bus interface communicatively coupled to the serial bus hub and configured to receive additional user input.

3. The thin-client terminal system of claim 1, further comprising a security circuit configured to authenticate the thin-client terminal system, wherein based on a determination that the thin-client terminal system is unauthentic, the security circuit prevents the thin-client terminal system from interfacing with the thin-client server system.

4. The thin-client terminal system of claim 3, wherein the security circuit configured to authenticate the thin-client terminal system comprises consulting a centralized licensing server to determine that an encrypted serial number in the security circuit is authentic and has been activated.

5. The thin-client terminal system of claim 3, wherein the security circuit configured to authenticate the thin-client terminal system comprises using a smartcard coupled to the security circuit to activate the thin-client terminal system.

6. The thin-client terminal system of claim 3, wherein the security circuit configured to authenticate the thin-client terminal system comprises the security circuit receiving a license code enabling the thin-client terminal system to operate.

7. The thin-client terminal system of claim 1, wherein the serial bus-to-video circuit is further configured to render a second video display device using the video signal.

8. A server system for supporting a thin-client terminal system, the server system comprising:
a video subsystem comprising:
a screen buffer configured to store video data for the thin-client terminal system; and
a serial bus video driver configured to drive a video signal to the thin-client terminal system using the stored video data;
a thin-client input driver configured to process input data received from the thin-client terminal system; and
a serial bus host controller configured to transmit the video signal to a serial bus hub of the thin-client terminal system.

9. The thin-client server system of claim 8, wherein the serial bus host controller is further configured to receive an identifier from the serial bus hub of the thin-client terminal system, the receipt of the identifier causing the serial bus host controller to activate a serial bus driver associated with the thin-client terminal system.

10. The thin-client server system of claim 8, further comprising a thin-client serial bus audio driver configured to drive an audio signal to the thin-client terminal system via the serial bus host controller.

11. A thin-client terminal system, comprising:
means for connecting the thin-client terminal system to a thin-client server system;
means for identifying the connecting means as associated with the thin-client terminal system;
means for receiving output data from the thin-client server system;
means for transmitting user input data to the thin-client server system;
first means for receiving the user input data;
means for converting the received output data into a video signal; and
means for rendering a first video display device using the video signal.

12. The thin-client terminal system of claim 11, further comprising second means for receiving the user input data.

13. The thin-client terminal system of claim 11, further comprising means for authenticating the thin-client terminal system, wherein based on a determination that the thin-client terminal system is unauthentic, the authenticating means prevents the thin-client terminal system from interfacing with the thin-client server system.

14. The thin-client terminal system of claim 13, wherein the authenticating means consults a centralized licensing server to determine that an encrypted serial number in the security circuit is authentic and has been activated.

15. The thin-client terminal system of claim 13, wherein the authenticating means uses a smartcard coupled to the security circuit to activate the thin-client terminal system.

16. The thin-client terminal system of claim 13, wherein the authenticating means receives a license code enabling the thin-client terminal system to operate.

17. The thin-client terminal system of claim 11, wherein the rendering means renders a second video display device using the video signal.

18. A method of providing a thin-client terminal system, the method comprising:
connecting a serial bus hub to a serial bus host controller in a server system;
transmitting an identifier to the serial bus host controller identifying the serial bus hub as being associated with the thin-client terminal system;
receiving serial output data from the server system;
converting received serial output data into a video signal;
rendering a first video display device using the video signal; and
transmitting user input data via the serial bus hub to the thin-client server system, the user input data received by a serial bus interface communicatively coupled to the serial bus hub.

19. The method of claim 18, further comprising authenticating the thin-client terminal system, wherein based on a determination that the thin-client terminal system is unauthentic, a security circuit prevents the thin-client terminal system from interfacing with the thin-client server system.

20. The method of claim 19, wherein the authenticating comprises consulting a centralized licensing server to determine that an encrypted serial number in the thin-client terminal system is authentic and has been activated.

21. The method of claim 19, wherein the authenticating comprises using a smartcard coupled to the security circuit to activate the thin-client terminal system.

22. The method of claim 19, wherein the authenticating comprises receiving a license code enabling the thin-client terminal system to operate.

23. The method of claim 18, further comprising rendering a second video display device using the video signal.
